(19) United States
(12) Patent Application Publication
(10) Pub. No.: US 2026/0297294 A1
(43) Pub. Date: Oct. 1, 2026

(54) LIGHTWEIGHT EPOXY RESIN CORE FOR A HOLLOW COMPOSITE PART

(71) Applicant: SAFRAN AIRCRAFT ENGINES, Paris (FR)

(72) Inventors: Didier FROMONTEIL, MOISSY-CRAMAYEL (FR); Matteo MINERVINO, MOISSY-CRAMAYEL (FR)

(73) Assignee: SAFRAN AIRCRAFT ENGINES, Paris (FR)

(21) Appl. No.: 18/713,972

(22) PCT Filed: Nov. 23, 2022
(86) PCT No.: PCT/FR2022/052157

§ 371 Date: Jan. 8, 2026

(30) Foreign Application Priority Data
Dec. 3, 2021 (FR) FR2112921

(51) Int. Cl. C08K 3/26; B29C 44/02; B29K 63/00; C08G 59/24; C08J 3/20; C08J 5/04

(52) U.S. Cl. CPC C08K 3/26; B29C 44/02; C08G 59/245; C08J 3/201; C08J 5/042; B29K 2063/00; B29K 2995/0063; B29K 2995/0077; C08J 2363/02; C08K 2003/262

(57) ABSTRACT

A method for manufacturing a lightweight epoxy resin core material having a volume mass from 150 kg/m3 to 250 kg/m3 by a method including: incorporating bicarbonate into an epoxy resin that is based on: diglycidyl ether of bisphenol F; and/or diglycidyl ether of bisphenol A, the incorporating performed at a temperature from 60° C. to 100° C.: introducing the modified epoxy resin from the incorporating step into a closed mold at a temperature from 60° C. to 100° C.; and curing the modified epoxy resin introduced into the closed mold at a polymerisation temperature of the epoxy resin. The present disclosure further includes the uses thereof for producing cores for hollow parts configured for use in the aeronautical, aerospace and automotive industries; medical and wind turbine technologies; wagons; ships; and/or sporting goods.

### TECHNICAL FIELD OF THE INVENTION

This invention relates to a method for manufacturing a lightweight epoxy resin core, to a lightweight epoxy resin obtained by the method of the invention, and to the uses thereof for producing cores for hollow parts intended, in particular for the aeronautical, aerospace and automotive industries, medical technologies, wind turbines, wagons and ships and sporting goods.

### TECHNICAL BACKGROUND

For producing hollow parts or structures made of reinforced composite material, such as hollow 3D woven composite vanes or outlet guide vanes, designated by the acronym OGV (Outlet Guide Vane), generally use a foam core that remains in the part or a core that has to be removed afterwards.

The removal of the core provides the greatest weight reduction, but is also the most difficult to industrialise because it is not always easy to remove the core.

If, for example, a fusible core is used, it is essential to provide the necessary calories to melt it, while taking care not to damage the part.

It is also necessary to provide an outlet orifice allowing to evacuate the residues from the core. However, the arrangement of such an outlet orifice is restrictive because it is imperative to take account of a concentration of stresses generated in the vicinity of the outlet orifice.

Such hollow composite structures achieve their full potential when the core is lightweight and resistant to compression, shear and pressure, even at high temperatures (notably over 100° C.).

However, finding a material which, on the one hand, allows the best possible core to be designed in terms of weight, compressive strength, shear strength, cost, etc. and, on the other hand, which is compatible with the constituent material of the composite part or structure, in particular an epoxy resin reinforced with glass, carbon or aramid fibers, preferably with carbon fibers, is not easy.

Currently, in the aerospace industry, the epoxy resins based on bisphenol F diglycidyl ether, also referred to as by the acronym DGEBF, and/or based on bisphenol A diglycidyl ether, also referred to as by the acronym DGEBA, such as, for example, the epoxy resin PR520 marketed by Solvay, is very commonly used to manufacture the composite parts or structures, such as the fan vanes, the casings or the wedges, using a vacuum resin transfer moulding method, also referred to as VARTM (Vacuum Assisted Resin Transfer Moulding), in which the outer mould is replaced by a membrane subjected to an oil pressure.

Such a vacuum resin transfer moulding method is described, for example, in the publication “Modelling the VARTM Composite Manufacturing Process Xiaolan Song, Alfred C. Loos, Brian W. Grimsley, Roberto J. Cano, Pascal Hubert”.

CN 108 705 829 describes a sandwich panel based on lightweight epoxy foam which can be used in technical fields such as automobiles, rail transport, ships and aerospace, warships, military aircraft, planes, etc. The sandwich panel comprises, from the outside inwards, an outer layer, an epoxy foam core and an inner layer. The epoxy foam core is formed by foaming a composite material comprising a bisphenol A epoxy resin or a bisphenol F epoxy resin and a foaming agent which may be sodium bicarbonate or ammonium bicarbonate. The volume mass/density of the lightweight epoxy foam is between 150 and 1000 kg/m³ (paragraph [0029]).

U.S. Pat. No. 5,274,006 describes a foaming epoxy resin composition that can be used in fields such as automobiles, vehicles, household appliances, building materials, etc. The foaming epoxy resin composition comprises, as essential elements, a liquid epoxy resin which may be a diglycidyl ether using bisphenol A or bisphenol F, a diglycidyl ether of hydrogenated bisphenol A, and a foaming agent. The list of the inorganic foaming agents includes sodium bicarbonate. In the examples, the epoxy resin is a bisphenol A-based resin and the foaming agent is azodicarbonamide.

As part of the development of new hollow parts or structures made of reinforced composite material, in particular the outlet guide vanes or the fan vanes, the incorporation of a foam core, in other words a cellular material of the polyurethane, polystyrene or melamine type in particular, is desirable in order to reduce the overall weight while ensuring the desired mechanical characteristics and vibration resistance.

At present, the known foams are expensive and pose problems during the injection operation, in particular due to an incompatibility with the resin used, in particular with the epoxy resin PR520 marketed by Solvay.

On the other hand, the cores whose constituent material is compatible with the composition of the epoxy resin based on bisphenol F diglycidyl ether, such as the epoxy resin PR520 marketed by Solvay, will de facto be compatible with other epoxy resins based on bisphenol F diglycidyl ether and/or based on bisphenol A diglycidyl ether for which the curing temperature is at least 170° C.

As part of the development of hollow parts or structures made of reinforced composite material, there is a real need for a core material that is compatible with the composite parts or structures, allowing to improve the core/part or core/structure bond.

In particular, there is a real need for a material for the core of hollow parts or structures made of reinforced composite material that is:
light, i.e. with a volume mass less than or equal to 300 kg/m³, in particular less than or equal to 200 kg/m³,
compressive strength, i.e. in particular a compressive strength of less than 10 MPa, in particular at elevated temperatures, in particular a temperature of at least 150° C.), and
easy to implement under industrially attractive conditions, particularly in terms of cost.

### SUMMARY OF THE INVENTION

The aim of the present invention is precisely to meet these needs, by providing a method for manufacturing a lightweight epoxy resin core, in particular having a volume mass of between 150 kg/m³ and 250 kg/m³, comprising at least:
an incorporation step (A), during which sodium bicarbonate is incorporated into an epoxy resin, in particular an epoxy resin based on
   diglycidyl ether of bisphenol F, and/or
   diglycidyl ether of bisphenol A,
in particular at a temperature of between 60° C. and 100° C.;
an introduction step (B), during which the modified resin from the incorporation step (A) is introduced into a closed mould, in particular at a temperature of between 60° C. and 100° C.; and
a curing step, during which the modified resin introduced into a closed mould is cured at a polymerisation temperature of the resin.

One of the advantages of the method is that the material of the core is compatible with the hollow parts, particularly the hollow composite parts comprising such a core.

In the introduction step B), the modified epoxy resin core can be manufactured in a closed mould by low-pressure injection (for example at a pressure of less than 0.7 MPa) or simply by introducing a quantity of resin by casting before closure of the mould.

A compression or compression-transfer moulding method can also be implemented.

It then follows the curing cycle of the resin as the same resin is used for the final part.

The method allows to manufacture a core the mass of which is lightweight, leading to a reduction in the weight of the parts, particularly composite parts, in which it is integrated.

The invention also relates to a lightweight epoxy resin based on bisphenol F diglycidyl ether and/or bisphenol A diglycidyl ether obtained by an incorporation step (A) of a method according to the invention.

The volume mass of this lightweight epoxy resin, which may also be referred to as foam or foamed resin, is between 150 kg/m³ and 250 kg/m³, specifically 205 kg/m³.

The lightweight epoxy resin obtained by the method of the invention has a compressive strength of between 1 and 25 MPa, in particular between 1 and 10 MPa, more particularly between 2 MPa and 8 MPa, specifically greater than or equal to 2 MPa, in particular equal to 7.1 MPa, determined according to ASTM D6641.

The invention also concerns the use of a method according to the invention and/or a lightweight epoxy resin obtained by the method of the invention.

Another object of the invention relates to a method for producing hollow parts or structures implementing a step of manufacturing a core of lightweight epoxy resin by a method according to the invention and/or a lightweight epoxy resin obtained by the method of the invention.

The invention also relates to a hollow part made of epoxy resin reinforced in particular with carbon fibers, comprising a core made of lightweight epoxy resin obtained by a method according to the invention.

### BRIEF DESCRIPTION OF THE FIGURES

The invention will be better understood and other characteristics and advantages of the invention will become apparent from the reading of the detailed description which follows, comprising embodiments given by way of illustration with reference to the appended drawings presented by way of non-limiting examples, which may serve to complete the understanding of the present invention and the description of its embodiment and, where appropriate, contribute to its definition, in which:

FIG. 1 represents an image of the surface of a sample prepared by the method of example 1, using a photographic apparatus.

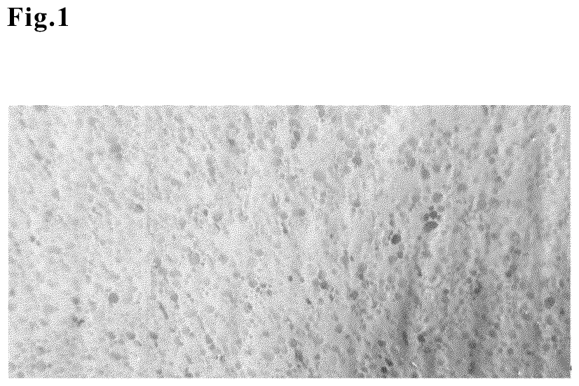

### DETAILED DESCRIPTION OF THE INVENTION

The present invention relates to a method for manufacturing a lightweight epoxy resin core, i.e. the volume mass of which has been reduced, in particular having a volume mass of between 150 kg/m³ and 250 kg/m³, comprising at least the following steps:
an incorporation step A), during which sodium bicarbonate is incorporated into an epoxy resin, in particular an epoxy resin based on
   diglycidyl ether of bisphenol F (DGEBF), and/or
   diglycidyl ether of bisphenol A (DGEBA),
in particular at a temperature of between 60° C. and 100° C.; and
an introduction step B), during which the modified resin from the incorporation step A) is introduced into a closed mould, in particular at a temperature of between 60° C. and 100° C.

The invention also applies when the bicarbonate incorporated into the resin during the incorporation step A) is potassium bicarbonate, lithium bicarbonate, calcium bicarbonate and ammonium bicarbonate. Particular attention will be paid to ensuring that the product degradation temperature is compatible with the resin and the transformation cycle.

In addition, all types of epoxy resins can be used. Similarly, a particular attention will be paid to ensuring that a different and appropriate decomposition product is used for each transformation cycle.

According to one embodiment of the invention, the epoxy resin used in the manufacture of the core is based on the diglycidyl ether of bisphenol F (DGEBF), in particular the epoxy resin PR520 marketed by Solvay.

One advantage of the method is that the material of the core is compatible with hollow parts or structures made of composite material comprising such a core. In particular, the hollow parts or structures made of composite material are made of epoxy resin PR520 marketed by Solvay.

During the incorporation step A), the bicarbonate, in particular the sodium bicarbonate, is incorporated into the epoxy resin, advantageously using a rotary mechanical paddle mixer known to the person skilled in the art.

The bicarbonate is therefore incorporated into the epoxy resin at a temperature of between 60° C. and 100° C., in particular at a temperature of between 70° C. and 90° C.

The bicarbonate will degrade during the curing cycle, in particular at a temperature of between 160° C. and 180° C., in particular by releasing a CO₂ gas which allows the epoxy resin to expand.

The bicarbonate is incorporated into the epoxy resin in the incorporation step A) at ambient or atmospheric pressure. Alternatively, the incorporation of the bicarbonate into the epoxy resin in the incorporation step A) can be carried out under a reduced pressure, for example between −700 mbar and −950 mbar. The rate of incorporation of the bicarbonate into the epoxy resin depends on the desired expansion rate of the epoxy resin. The rate of incorporation of bicarbonate, specifically sodium bicarbonate, can vary from 1% to 20%, preferably from 2.5% to 10% by weight, based on the weight of the resin.

The epoxy resin modified in this way at the end of the incorporation step A) is then used in the introduction step B) to be introduced into a closed mould, in particular at a temperature of between 60° C. and 100° C., in particular between 70° C. and 90° C.

In the introduction step B), the modified epoxy resin core can be manufactured in a closed mould by low-pressure injection, for example at a pressure of less than 0.7 MPa, or simply by introducing a quantity of modified epoxy resin by casting before closing the mould. A compression or compression-transfer moulding method can also be implemented.

According to a particular embodiment of the method for manufacturing a lightweight epoxy resin core according to the invention, the duration of the introduction step B) may be 2 hours. In another particular embodiment of the method for manufacturing a lightweight epoxy resin core according to the invention, the temperature of the introduction step B) can be 180° C.

Preferably, the introduction step B) of the method for manufacturing a lightweight epoxy resin core according to the invention is carried out without applying an external pressure greater than the solubility pressure of the gases. In particular, the introduction step B) of the method for manufacturing a lightweight epoxy resin core according to the invention is carried out in a sealed mould without applying pressure.

The method for manufacturing a lightweight epoxy resin core of the invention allows to manufacture a core whose material is similar or even identical to the material of the hollow part or structure made of composite material, possibly reinforced. As a result, the interface between the core and the hollow part or structure will actually be stronger than if the materials were not similar or identical. As a result, the core can contribute to the mechanical strength of the hollow part or structure.

The introduction of bicarbonate into the epoxy resin leads to obtain a “lightweight” foam, i.e. with a volume mass of between 150 kg/m³ and 250 kg/m³, which can be used to produce cores for hollow parts or structures made of composite material.

The lightweighting of the cores leads to the lightweighting of the parts or of the structures made of composite material comprising it.

The use of the same material for the core and the part or of the structure made of reinforced composite material, namely the epoxy resin as defined above, allows to improve the bond between the core and the part or of the structure. The cross-linking reaction of the material of the core can optionally be stopped and be completed during the final curing of the part or of the composite structure.

At this step, the core has the dimensions of the mould because the gas released creates an internal pressure. In the case of an under-polymerisation, i.e. an incomplete polymerisation in which the resin has not fully reacted, the shrinkage can be partially compensated for by the size of the mould.

The invention also concerns a lightweight epoxy resin based in particular on
diglycidyl ether of bisphenol F (DGEBF) and/or
diglycidyl ether of bisphenol A (DGEBA),
   obtained by the method for manufacturing a lightweight epoxy resin core of the invention. More particularly, the resin based on bisphenol F diglycidyl ether and/or bisphenol A diglycidyl ether is obtained by an incorporation step (A) of the method of the invention.

The lightweight epoxy resin, which may also be referred to as “foamed resin”, obtained by the method for manufacturing a lightweight epoxy resin core of the invention has a lower volume mass of between 150 kg/m³ and 250 kg/m³. The volume mass of the lightweight resin may be, for example, 205 kg/m³.

The lightweight epoxy resin obtained by the method for manufacturing a lightweight epoxy resin core of the invention has a compressive strength of between 1 MPa and 25 MPa, in particular between 1 MPa and 10 MPa, more particularly between 2 MPa and 8 MPa. The compressive strength of the lightweight resin can be, for example, greater than or equal to 2 MPa, in particular 7.1 MPa. The compressive strength can be determined by testing on a compression machine, in accordance with ASTM D6641.

In a particular mode of the invention, the lightweight epoxy resin obtained by the method of the invention has a volume mass of 205 kg/m³ and a compressive strength of 7.1 MPa.

The invention also relates to
the use of a method for manufacturing a lightweight epoxy resin core according to the invention, or
the use of a lightweight epoxy resin obtained by the method for manufacturing a lightweight epoxy resin core of the invention,
   for the production of cores for hollow parts, and/or
a hollow part made of epoxy resin reinforced in particular by carbon fibers, comprising a core of lightweight epoxy resin obtained by a method according to the invention.

Hollow parts of this kind have particularly interesting applications in the aeronautics, aerospace and automotive industries, in medical and wind technologies, in the construction of wagons or ships, and in the production of sports goods.

Another object of the invention concerns a method for producing panels in the planes, helicopter blades, outlet guide vanes, also referred to as OGV, fan vanes with a ultra-high bypass ratio, also referred to as UHBR, and/or variable pitch fan vanes, also referred to by the acronym VPF for “Variable Pitch Fan”, implementing a step of manufacturing a lightweight epoxy resin core by a method according to the invention or a lightweight epoxy resin obtained by the method of the invention.

These hollow parts can be, for example, panels in the planes, helicopter blades, outlet guide vanes, ultra-high bypass ratio fan vanes, variable pitch fan vanes, boat or ski shells.

### EXAMPLES

### Example 1: Method for Manufacturing a Lightweight Epoxy Resin Core According to the Invention

To produce the lightweight epoxy resin core, we incorporate 2.5 g of sodium bicarbonate into 100 g of epoxy resin PR520 marketed by Solvay.

The sodium bicarbonate is incorporated into the epoxy resin PR520 marketed by Solvay, heated to 70° C. with a mechanical paddle mixer.

The incorporation rate of the sodium bicarbonate into the resin at the end of this incorporation step is 2.5% by weight, relative to the weight of the resin.

The resin modified in this way is then used to manufacture the core using the same temperature range as for the epoxy resin PR520 marketed by Solvay.

The resin modified in this way is then introduced into a closed mould by low-pressure injection, in particular below 2 MPa.

The volume mass of the resin modified in this way at the end of the manufacturing method is 170 kg/m³. It is determined by double weighing.

It also has a compressive strength of 2 MPa, determined in accordance with ASTM D6641.

1. A method for manufacturing a lightweight epoxy resin core, in particular having a volume mass of between 150 kg/m³ and 250 kg/m³, comprising at least:
an incorporation step (A), during which bicarbonate, in particular sodium bicarbonate, is incorporated into an epoxy resin, in particular an epoxy resin based on
diglycidyl ether of bisphenol F, and/or
diglycidyl ether of bisphenol A,
in particular at a temperature of between 60° C. and 100° C.;
an introduction step (B), during which the modified resin from the incorporation step (A) is introduced into a closed mould, in particular at a temperature of between 60° C. and 100° C.; and
a curing step, during which the modified resin introduced into a closed mould is cured at a polymerisation temperature of the resin.

2. The method according to claim 1, characterised in that the rate of incorporation of bicarbonate, in particular of sodium bicarbonate, in the resin is from 1% to 20% by weight, relative to the weight of the resin.

3. The method according to one of claim 1 or 2, characterised in that the epoxy resin is based on the diglycidyl ether of bisphenol F.

4. The method according to any one of the preceding claims, characterised in that the modified resin is introduced into a closed mould in the introduction step (B) by low-pressure injection, in particular at a pressure of less than 0.7 MPa, or by casting before closure of the mould.

5. A lightweight epoxy resin based on bisphenol F diglycidyl ether and/or bisphenol A diglycidyl ether obtained by an incorporation step (A) of a method according to any one of the preceding claims, having a volume mass of between 150 kg/m³ and 250 kg/m³.

6. The lightweight epoxy resin as claimed in claim 5, characterised in that the lightweight epoxy resin has a volume mass equal to 205 kg/m³.

7. The lightweight epoxy resin according to one of claim 5 or 6, characterised in that the lightweight epoxy resin has a compressive strength of between 1 MPa and 25 MPa, in particular between 1 MPa and 10 MPa, more particularly between 2 MPa and 8 MPa, specifically greater than or equal to 2 MPa, in particular equal to 7.1 MPa, determined according to ASTM D6641.

8. A use of a method according to any one of claims 1 to 4 and/or of a lightweight epoxy resin according to any one of claims 5 to 7, for the production of core for hollow parts or structures.

9. A method for producing hollow parts or structures implementing a step of manufacturing a core of lightweight epoxy resin by a method according to any one of claims 1 to 4 and/or a lightweight epoxy resin according to any one of claims 5 to 7.

10. A hollow part made of epoxy resin reinforced, in particular, with carbon fibers, comprising a core made of lightweight epoxy resin according to any one of claims 5 to 7.
